(19) United States
(12) Patent Application Publication
(10) Pub. No.: US 2012/0166310 A1
(43) Pub. Date: Jun. 28, 2012

(54) METHOD AND SYSTEM FOR BROKERING INDUSTRIAL SERVICE CONTRACTS

(75) Inventors: David Paul Werklund, Calgary (CA); Michael Norman Lussier, Calgary (CA); Michael Allan Weber, Airdrie (CA); Richard Walter Bellamy, Calgary (CA)

(73) Assignee: CCS CORPORATION, CALGARY (AL)

(21) Appl. No.: 13/394,275

(22) PCT Filed: Aug. 18, 2010
(86) PCT No.: PCT/CA2010/001221

§ 371 Date: Mar. 5, 2012

Related U.S. Application Data
(60) Provisional application No. 61/249,452, filed on Oct. 7, 2009.

(51) Int. Cl. G06Q 30/00

(52) U.S. Cl. 705/26.41

(57) ABSTRACT

A system and method for brokering industrial service contracts is described. The system registers customer users and service provider users. Further, customers may enter order data corresponding to a request for industrial service. Service provider users may enter qualification data corresponding to their ability or capacity to take on service contracts. The system implements a matching module based on the customer user-entered order data to generate a ranked list of suitable service provider users. Sequential offers are made to the qualified service providers in ranked order until an offer is accepted.

### CROSS-REFERENCE TO RELATED APPLICATIONS

This application is filed under 35 U.S.C. 371 and claims priority from International Application PCT/CA2010/001221 with an International Filing Date of Aug. 18, 2010. This application also claims the benefit of U.S. Provisional Application No. 61/249,452 filed on Oct. 7, 2009, which is incorporated herein by reference.

### BACKGROUND OF THE INVENTION

Electronic communications and purchases have become commonplace, with many companies conducting business primarily over the Internet. Mobile communications are pervasive, and paperless business transactions are generally favored.

Many companies currently procure business services based on previous experience or word of mouth. That is, a company will typically procure additional services or request referrals from companies with whom they have current business dealings. This approach minimizes the cost and risk associated with otherwise randomly identifying and engaging a suitable service provider.

Notably, with respect to industrial services, many criteria must be considered each time services are required, such as safety certification, equipment requirements, qualifications of personnel involved, timing of the service request, et cetera. As a result, a suitable current contact or referral may not be found. In this case, the customer would typically conduct a search to identify a limited number of potential suppliers based on various subjective factors, and then contact each company to select a service provider. This process is often time consuming and may result in less than satisfactory results.

### 1. Field of the Invention

The present invention relates generally to service brokering systems. More particularly, the present invention relates to a method and system for matching a customer order for a specialized industrial service with a qualified vendor willing to provide such service.

### SUMMARY OF THE INVENTION

In a first aspect, the present invention provides a method for brokering industrial service contracts, the method comprising the steps of:

collecting qualification data obtained from a plurality of industrial service providers;

storing the qualification data within a database;

obtaining an industrial service request from a user, the service request comprising one or more service parameter inputs;

filtering the qualification data on the basis of the service parameter inputs to generate a qualification list of service providers qualified to fulfill the service request;

ranking each qualified service provider based on the correspondence of one or more service parameter inputs with the qualification data of that service provider;

making sequential, time-limited offers corresponding to the industrial service request on behalf of the user, to the qualified service providers in ranked order; and

confirming an accepted offer with the accepting service provider and the user.

In one embodiment, the method further comprises the step of periodically re-collecting qualification data.

In a further embodiment, the method further comprises the step of periodically re-filtering the qualification data to update the qualification list.

In a further embodiment, the method further comprises the step of periodically re-ranking the service providers included in the qualification list.

One or more of the steps in the method may be repeated until an offer is accepted by a qualified service provider.

In another embodiment, the method further comprises the step of prioritizing the service parameter inputs to assign a weight value to at least one of the service parameter inputs. The weight value may be used during the filtering step to eliminate one or more service providers from the qualification list and/or the weight value may be used during the ranking step to compare qualified service providers based on the correspondence of each service parameter input with the available qualification data of each service provider.

In an embodiment, the qualification data comprises at least one of: GPS location of the service provider, capacity of the service provider to accept a new contract, estimated price of completing the service, safety certification of the service provider, equipment availability, and estimated time to reach the service location.

In a further embodiment, the method further comprises the step of requesting additional qualification data from qualified service providers, based on the service parameter inputs.

In an embodiment, the step of ranking comprises calculating a score for each service provider based on the degree of correspondence between each service parameter input and the qualification data available for that service provider.

In an embodiment, the method further comprises the step of modifying the offer to gain offer acceptance by a qualified service provider.

In another embodiment, the method further comprises the step of offering the service request to two or more service providers for competitive bids when the time-limited offers do not result in acceptance of an offer.

In another embodiment, the service request is offered to two or more service providers in an auction format.

In an embodiment, the customer service parameter inputs comprise at least one of: a completion deadline; a fixed price; a maximum price; a preferred service provider identity; a listing of unsuitable service providers; a safety certification requirement; a prerequisite requirement; carriage of a specific insurance policy; specific equipment request; a minimum reliability rating.

In an embodiment, the industrial service request is selected from the group consisting of: a request for equipment maintenance, a request for training; a request for inspection; a request for shipping of goods; a request for an expert opinion; a request for service access to a skilled tradesperson; a request for geological services; a request for testing; a request for surveillance; a request for security services; a request for cleaning services; and a request for consultant services.

In another embodiment, each customer service parameter input comprises a user-entered priority value. The priority value may be entered in respect of service parameter inputs that the user considers to be required of the service provider. Further, the qualification step may exclude service providers whose qualification data does not correspond to service parameter inputs associated with the priority value.

Further, the priority value may be a score entered by the user in respect of each service parameter input to weight the service parameters.

In an embodiment, the step of ranking each qualified service provider comprises the step of assigning a score to each service provider in respect of each service parameter input based on the correspondence of each service provider's qualification data to the prioritized service parameter inputs, and then ranking the qualified service provider.

In a further embodiment, the step of ranking each qualified service provider comprises: assigning a score to each service provider in respect of each service parameter input, based on the correspondence of each service parameter with the service provider's qualification data; and, in respect of each service provider, processing each score in respect of the user-entered priority value for each service parameter to arrive at an overall ranked list of service providers.

Service providers may be blinded to the identity of the user until an accepted offer is confirmed. Further, the user may be blinded to the identity of the service providers until an offer is confirmed.

In one embodiment of the method described herein, the offers are made confidentially to service providers.

In a second aspect, there is provided a system for brokering industrial service contracts, the system comprising:

a registration module for collecting registration data from customer users and service provider users, the registration module comprising: an input component for collecting order request data from customer users and qualification data from service provider users; and a database component for storing said order data and qualification data;

a matching module for querying the database in respect of the order request data to generate a match and resulting contract between a customer user and a service provider user, the matching module comprising: a processor for ranking service provider users with respect to the order request data, and for making sequential time-limited contract offers corresponding to the order request data to ranked service provider users, on behalf of the customer user.

In an embodiment, the input component comprises a website, mobile device, telephone line, system kiosk, or personal interaction. Further, the input component, database component, and matching module are connected by a data communication network.

In an embodiment, the system further comprises a request component for requesting additional data from a user. The additional data may be, for example, a confirmation input indicating acceptance of a contract by a user, additional qualification data, or additional order request data.

In an embodiment, the network is a dedicated network, LAN, WAN, or the Internet.

In a third aspect, there is provided a system for matching registered customer users in need of service, with registered service provider users qualified to provide the service, the system comprising:

a user interface for collecting service order data from customer users, and for collecting qualification data from service provider users;

a database for storing the service order data and the qualification data;

a communication interface for requesting input from users;

a processor for querying the database in respect of each service order and executing a matching module to generate a ranked list of qualified service provider users corresponding to the service order data; and

an offer module for generating contract offers corresponding to the service order, communicating said offers sequentially to the qualified service provider users in ranked order via the communication interface, and requesting acceptance of same within a specified period of time.

The input requested by the communication interface may be, for example, additional order data, additional qualification data, or GPS data.

In an embodiment, the user interface comprises a website, telephone, or mobile device network.

The communication interface may be a website, telephone, mobile device network, or other network.

Other aspects and features of the present invention will become apparent to those ordinarily skilled in the art upon review of the following description of specific embodiments of the invention in conjunction with the accompanying figures.

### BRIEF DESCRIPTION OF THE SEVERAL VIEWS OF THE DRAWINGS

Embodiments of the present invention will now be described, by way of example only, with reference to the attached Figures, wherein:

FIG. 1 is a schematic of a system for brokering service contracts, in one embodiment;

FIG. 2a-b is a schematic diagram of a decision tree used in a matching module for matching a customer with a service provider, in one embodiment;

FIG. 3 is a screen shot depicting user registration data fields, in one embodiment;

FIG. 4 is a screen shot depicting additional service provider user data fields;

FIG. 5 is a screen shot depicting order placement data fields; and

FIG. 6 is a schematic diagram of a system for collection and matching of customer user data with a qualified service provider, in one embodiment.

### DESCRIPTION OF THE PREFERRED EMBODIMENTS

### 1. Detailed Description

Generally, the present invention provides a method and system for matching a first registered user seeking industrial service, with another registered user willing and qualified to provide said service. A suitable match is located employing a method comprising any combination of at least two of the following steps: generating a list of qualified service providers from a register of users, ranking qualified service providers according to the specifications required/requested by the first user, sequentially offering the order to qualified service providers in ranked order, and offering the order up for auction to allow bidding by qualified registered service providers. The specific matching combination used to determine a suitable service provider is determined by the system based on the specifications of the service order, and on the number of qualified service providers found by the system for that service order.

Thus, for each service order, a listing of qualified users is transformed into a single user-service provider match, with the system generating a contract between the matched pair for completion of the order placed by the first user.

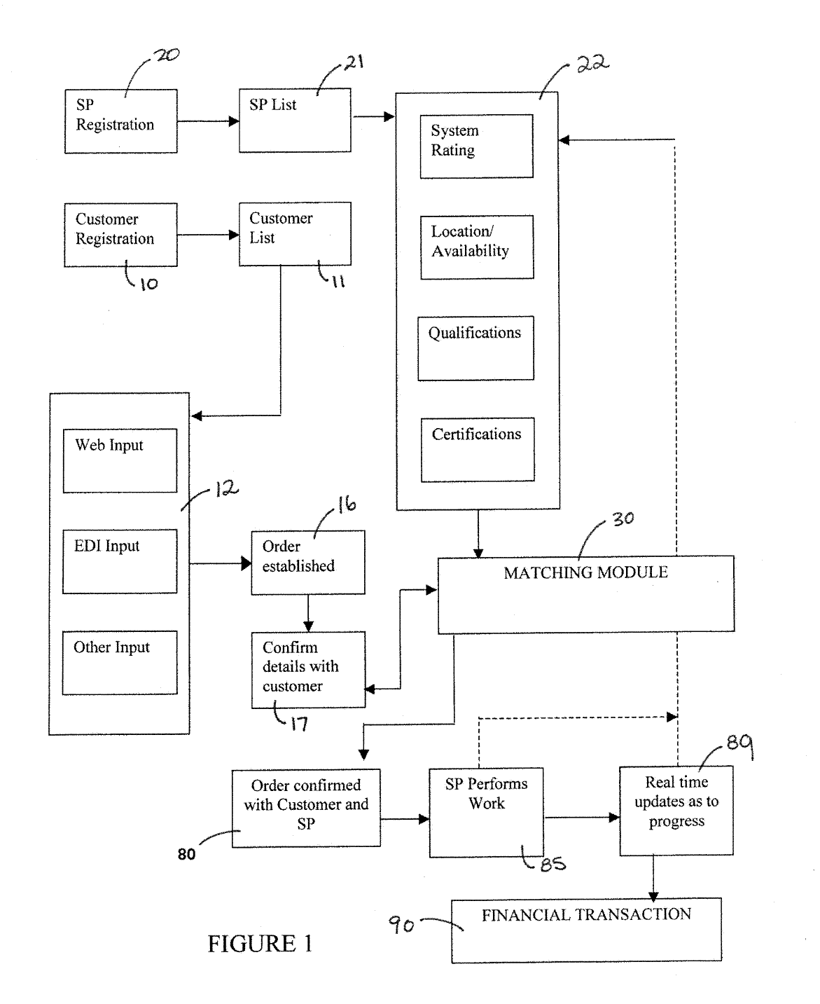

The system is generally shown in FIG. 1, in which customers and service providers are registered by entry of general contact and qualification data 10, 20, to generate a system customer list 11 and system service provider list 21. Customers may then place order requests, which are stored within an order database 12, defining a series of service orders 16. System data may be modified at any time, and the database may refreshed continually.

The system service provider list is also stored within a database 22. The database 22 may be refreshed continually to permit updates as to location and availability of service providers, and/or to adjust capability or reliability rating (if present).

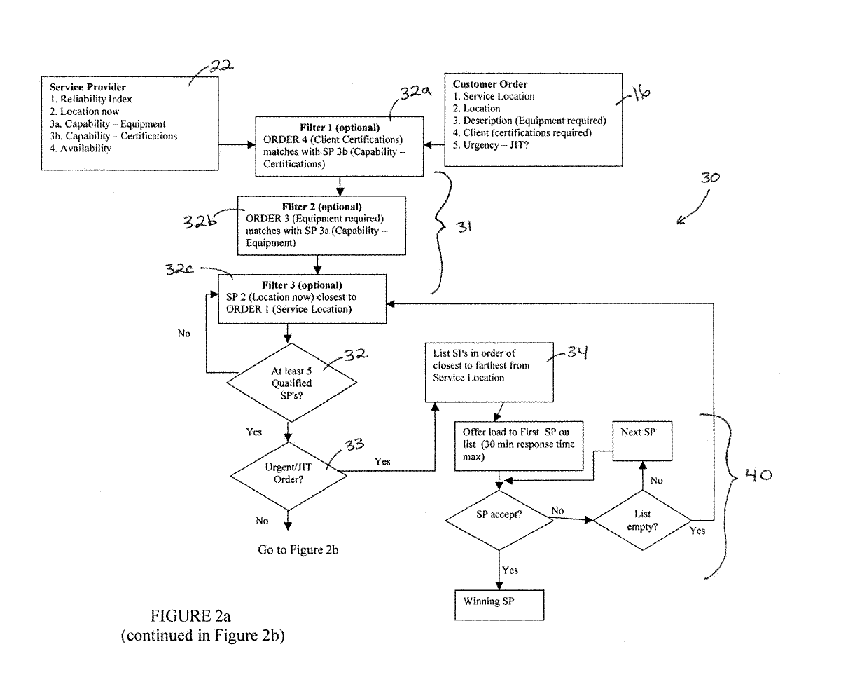

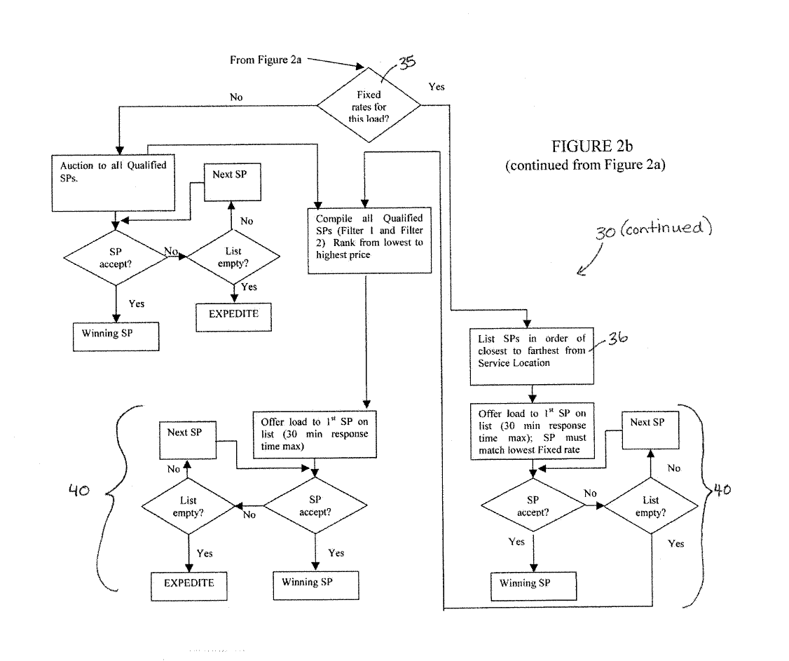

A matching module 30 (see FIG. 2a-b) completes a matching scheme for each service order 16 to fulfill the request for service, generating a contract between the requesting customer and the matched service provider. The identities of the parties are then revealed and any remaining service details provided 80. The service is completed 85 and the system is updated 89 to confirm completion and request feedback from the parties.

In the system shown in FIG. 1, the system operator may also act as intermediary with respect to the related financial transaction 90.

It should be noted that the present system may be used in an international, national or local setting, and may even be used within a company or family of companies to manage time and asset allocation, and performance.

Registration Module

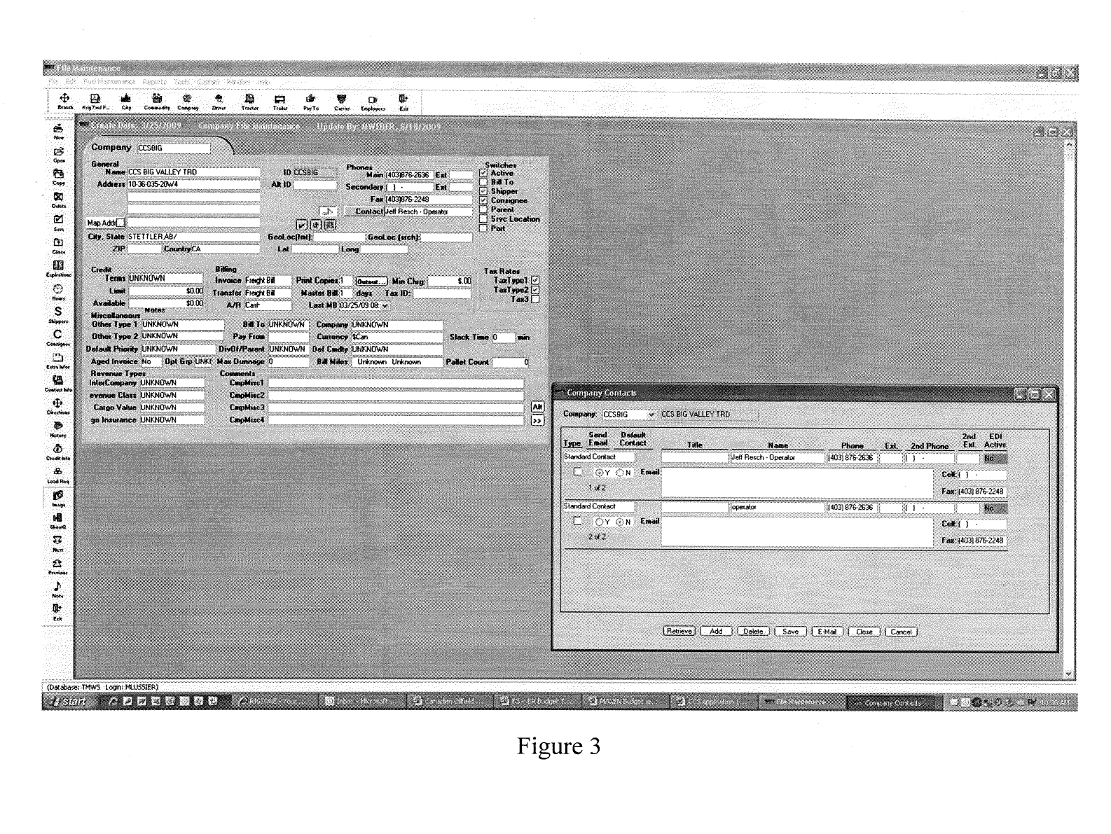

The registration module collects information from entities desiring access to the system. In order to become a registered user, an entity must provide a minimum amount of identifying information. With reference to FIG. 3, required identifying information may include: disclosure of the company name and address, name and contact information of all individuals authorized to use the system on behalf of the company, and credit and billing terms. Each registered used would require a username and password.

The registration module may be accessed online, by telephone or in person (with data entry by a system operator), by a mobile device, at a designated system kiosk, by electronic file transfer, or other suitable method. In any event, the registration data is collected and entered within the system registration database. The registration module may further collect customer and/or service provider data during the initial registration process.

If the user expects to place orders within the system, the user (termed a customer-user) may wish to enter additional information to simplify the ordering process. For example, the customer-user may wish to enter the appropriate business sectors for which services are typically requested, as well as set up standard service request templates. In addition, safety or equipment qualification requirements may be entered. For example, if the user is a supplier of chemicals, and it is expected that all of their order requests will be for transport of chemicals, the safety qualifications and equipment standards may be known and can be entered in the system in advance. Similarly, if the user is a heavy equipment rental company, their order requests may all relate to service of their equipment, in which case certain trade certifications may be required of the service provider. Such qualifications and/or certifications may be entered into the system upon registration. In addition, preferred service providers, maximum acceptable costs of service, insurance required, various potential service locations, terms of service acceptance, and other preferences may be entered.

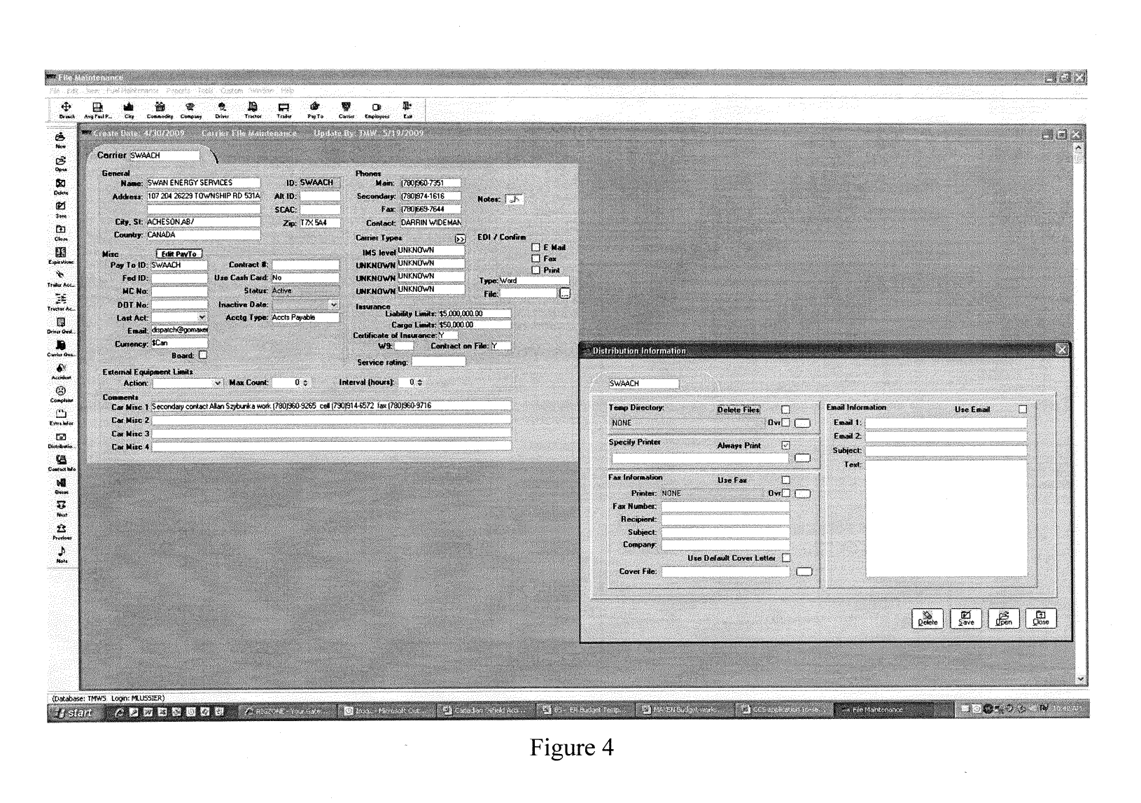

If the user registering within the system is a service provider (SP-user), the user may be prompted to enter any or all of the business sector, types of services provided, certifications and qualifications held, hazard precautions available, insurance carried, minimum cost, minimum lead time required to handle an order, capacity, and any other parameters or preferences relating to the ability of the company to provide services. The service provider may enter fixed rates, and may provide a link to their GPS system or transmitters for asset location and proximity calculations, which may be used by the system. A screen shot of data fields applicable to a freight carrier is shown in FIG. 4, in which the company name, address, contact information, and insurance limits may be entered. A specific service rating data field may be assigned by the system to indicate the SP-user is a new user. As the SP-user completes matched orders, this field may be updated, used to display ratings from past customer-users, or used for other system-assigned ratings.

In some instances, a user may be both a customer-user and a SP-user, (dual user). Additional preferences may be added by such users as appropriate, including separate contact information and locations for each function, or other customized details.

User interaction with the registration module may be facilitated by a system website, in which users are registered remotely using an internet connection, and customers may enter orders for services. Users may then receive updates requests, offers, and other communications from the system via a mobile device or at an interne terminal.

Once registered, a user log page is created, which is a secure page displaying only the company's information and orders/requests for service. Notably, no member may view the username or identity of another registered member, and additional user security may be added to a company's log page as desired. The user log page may allow the user to update fields or manipulate the matching module (see below) in real time.

### Placing a Request

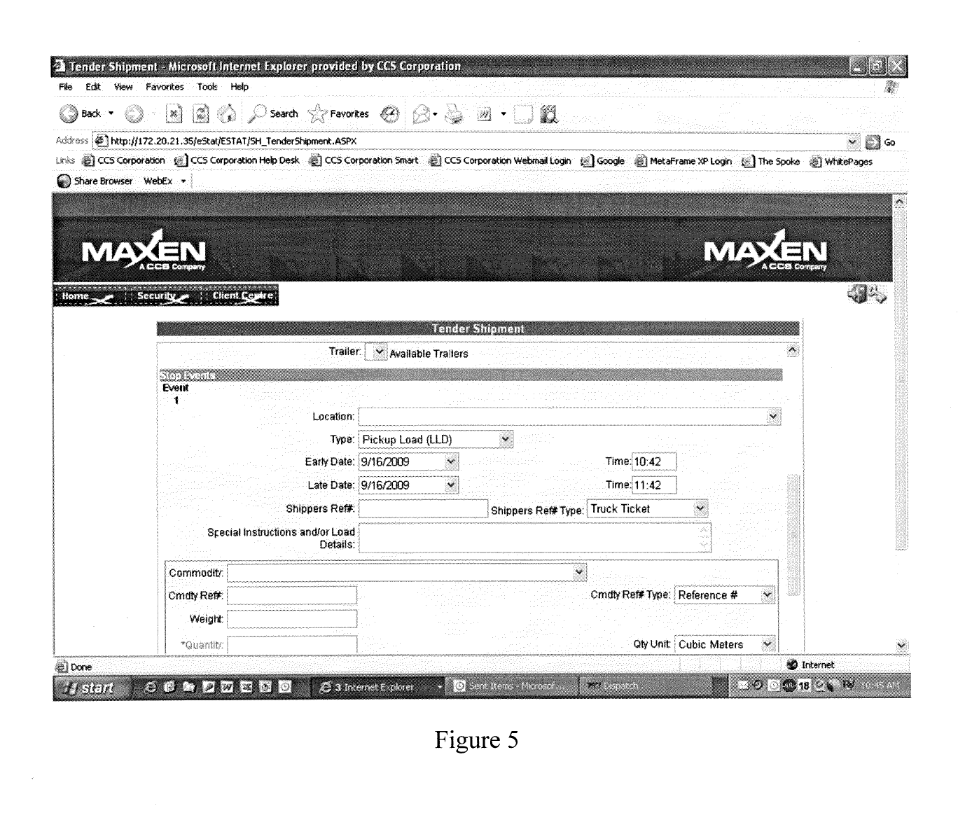

From the user log page or within the registration module, a customer-user or dual user may enter specific requests for service. A sample data entry screen is shown in FIG. 5.

Required fields are indicated as such, for example qualifications and certifications relating to safety and technical requirements, amount of insurance, etc. The preferred date range, location, price, urgency, and any other preferences may be indicated.

Further, the customer-user may prioritize or weight their preferences relating to each order. That is, if a particular request is urgent, and the cost of the service is irrelevant, this can be indicated within the request for service. Notably, these priorities/weights and preferences may not be visible to the service-provider users who are contacted regarding the request for service.

System operators may enter or modify orders placed by customer-users. For example, when an order is placed by phone, the system operator may enter the entire order on behalf of the customer-user. Customer orders may be placed by any means, for example, by mobile device, web interface, telephone, fax, in person, at a designated terminal/kiosk, data transfer, etc. Any of the order parameters may be amended at any time by the user or by system operators, or automatically by the system as necessary to complete the match. The finalized order parameters may be subject to confirmation 17 by the customer-user.

### Matching Module

With reference to FIGS. 2a and 2b, the matching module 30 processes information from the order database 12, and queries the service provider database 22 as necessary, filtering 31 as appropriate to generate a service provider qualification list for each order. This list is later or simultaneously used for ranking the service providers, and ultimately for matching one successful service provider with the order. The matching module is implemented, at least in part, by a processor, such that continuous sorting, queries, and matching are possible based on real time data updates of order parameters, service provider location, and other matching criteria.

### Qualification List

Each customer request/order is independently handled, and the general service provider-user database is queried to generate a list 32 of members qualified to fill each service request, based primarily on qualification requirements entered by the customer in placing the order, and on qualification data entered by the service providers. The system may further include or reject certain providers based on preference data entered by the customer and/or service providers, such as member reviews, reliability, member status, etc.

As shown in FIG. 2, for a given order/request 16, the service provider database 22 is queried to generate a list 32a of registered service providers possessing the appropriate certifications/qualifications required by the order. This list is then filtered again to generate a refined list 32b of certified/qualified service providers that have the appropriate equipment/capacity for completion of the order.

A third filter may be applied to eliminate service providers whose location is too distant for completion of the order within the requested time, resulting in location-refined list 32c.

Further filtering may be appropriate, depending on the specifications of the request as entered by the customer-user. For example, special requests for certain service providers, or to avoid certain service providers, may require further filtering. Alternatively, fewer filters may be applied, for example location filtering may not be required to generate the qualification list 32.

Notably, the database may be queried continuously to update the qualification list 32 in real time as new information becomes available. The system may query the database at any appropriate frequency or until a given point in time. In some circumstances, continual updates may be requested, particularly if few suitable Qualified service providers are found, or if location is of particular importance.

In some cases, the database may be queried until a minimum number of Qualified service providers (for example five service providers) are found. If a suitable number of Qualified service providers cannot be found, the filters may be relaxed (for example, the date or proximity range may be extended), which may require approval 17 from the customer-user who placed the order request.

The system may send further requests for qualification data to service provider-users in response to a customer order. For example, when a rush order is received, the system may generate a first Qualification List to exclude inappropriate service provider-users, and the system may then send a request (electronic or otherwise) to all qualified service providers to request updated location information. This may allow those SP-users without GPS capacity to provide a real-time update as to their location, so they may be considered for that particular order. The matching module may periodically query the service provider database 22 before and/or during the offer process to update the Qualification List 32 (and the Ranked List) by collecting updated service provider location data (or other data), service quotes, competitive bids, et cetera, which may change the order in which offers are presented to the qualified service providers.

The Qualification List 32 may be subject to Ranking (described below), prior to initiation of the Offer Module.

### Ranking of Qualified Service Providers

The Qualification List 32 may be subject to ranking using a decision tree, based on the parameters and preferences of the order. Ranking may be based on any factor or combination of factors, such as: proximity to the service location; reliability ratings of the service providers; location; capacity; estimated time to fill the service request; and/or estimated price of the service. Other factors may also be considered, and each factor may be weighted by the customer-user, by the system, or by a system operator.

With reference to the matching module shown in FIGS. 2a and 2b, if an order is indicated as a rush order/Just-In-Time (JIT) 33, the proximity to the service location will be considered the most critical factor for ranking. Qualified service providers are ranked in order of proximity to the service location 34.

If proximity is not the most critical factor, service providers on the Qualification List may be ranked by estimated or pre-negotiated rates 35 for the service in question, with the service providers listed from lowest to highest rate 36.

Further, the Qualification List may be ranked using various weighted or unweighted parameters, with the aggregate ranking score used to determine the ultimate ranking list sent to the Offer Module.

Alternatively, the Qualification List may be sent directly to the Offer Module without ranking.

In some instances, additional querying/ranking may continue to occur within the Offer Module so as to continually re-rank qualified service providers while Offers are being made, based on updates to the database.

### Offer Module

The Offer Module 40 receives the Qualification List or Ranked List from the Matching Module, and an offer is made sequentially to listed service providers, or to a number of service providers at once through an auction/bidding system. The Offer Module may be integrated within the Matching Module, or may be present as a separate system in communication with the Matching Module.

Offers may be made electronically, via web interface or mobile device for example, or by telephone, fax, email, or other suitable means. The offer typically would not include the identity of purchaser, and may not include all parameters of the order. For example, the potential service provider may not be informed of the urgency of the job or maximum acceptable price, to enhance competition and urgency in response.

### Sequential Offers to Ranked SPs

The order may be offered in sequence to ranked service providers, allowing each a fixed period of time for response. That is, the top-ranked service provider receives the first opportunity to accept the offer, and if the offer is not accepted within a fixed period of time, the offer to the top ranked service provider is rescinded. The offer is then made available to the next ranked service provider. Such sequential offers continue until an offer is accepted.

Should an offer be made to a service provider member who has provided fixed rates or pre-negotiated rates within the system, the offer may quote such rates.

If no offer is accepted via the sequential offers to ranked service providers, the sequential offers may be repeated. Alternatively, any step within the matching module may be repeated to generate a new ranked list, and new series of sequential offers made based on the new rankings. Further, the order database 12 and service provider database 22 may continue to be updated during the Offer Module, and continuous re-ranking may alter the sequence of offers as the availability or suitability of a given service provider is updated.

Repeat sequential offers may vary from the original series of sequential offers. For example, the price, time, or other order parameters may be altered to increase the probability of offer acceptance by one of the service providers. Accordingly, service providers receiving a repeat offer may not be aware that it is a repeat offer, as the purchaser identity is not provided and the parameters may have changed.

Should the Offer Module be unable to secure a match, the order may be offered to all qualified service providers in auction format. Auction results may be entered into the database and used in re-ranking of service providers.

### Auction

Rather than sequential offers by rank, or following an unsuccessful series of sequential offers, or as part of the ranking process, the order may be offered to all qualified and/or ranked service providers in an auction format or bid list. The auction format may also be suitable when a customer order is very specific, making filtering overly inclusive or exclusive. Various auction formats are possible, including:

Blind auction in which each service provider is blinded to bids from other service providers, with the best bid being named as the successful service provider. Alternatively, the resulting bids may be used to rank or re-rank qualified service providers, with results sent back to the Offer Module.

Timed auction in which the best bid or fastest service takes the order.

Instant auction, in which the first bid meeting the auction parameters (which may be hidden from the service providers) obtains the contract.

### Contract, Payment, etc.

Upon acceptance of an offer by the service provider, whether a direct offer or by the service provider placing a bid at auction, the service provider becomes contractually bound to the order, even if the system must later confirm acceptance. Once the system accepts the match, a contract is established between the ordering member and the service provider.

The system may handle the corresponding financial transactions, or may interface with an appropriate financial system.

### System

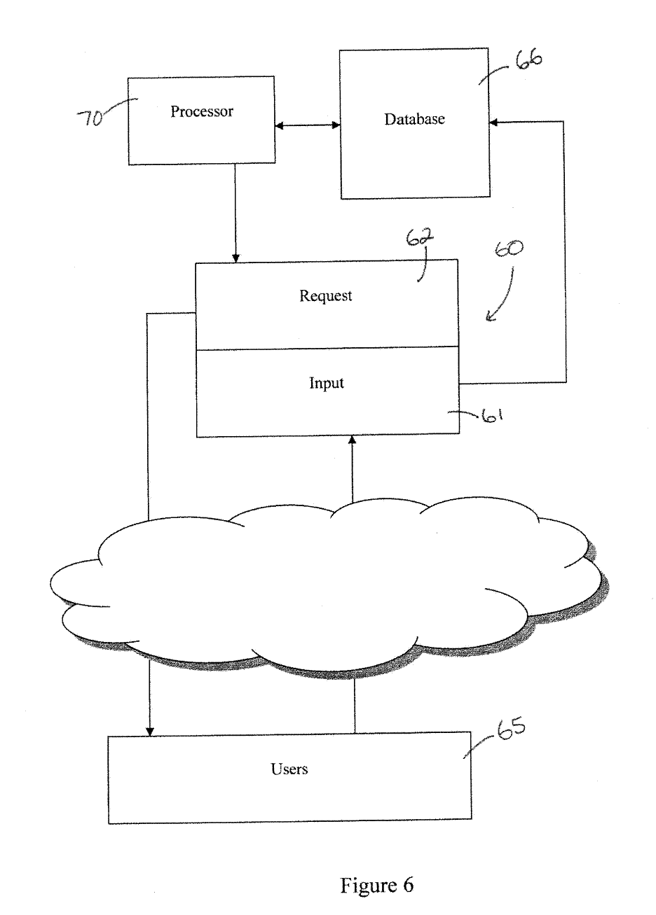

With reference to FIG. 6, a system is shown for use in implementation of a method as described above. Users 65, whether customer users or service provider users, may communicate with user interface 60. For example, users may register and enter data using input interface 61. The input interface may be a website, kiosk, order desk, etc, which may be accessed by any suitable means, for example by telephone, dedicated network, internet connection, mobile network, or otherwise. Data entered by users is stored in database 66, which may be separated into an order database 12 and a qualification database 22.

A processor 70, implements a matching module to match each customer order with a qualified service provider. When additional input is required from a user, the processor sends a request to the user through request interface 62. The additional input may be additional order data (for example, authorization to eliminate certain order criteria, or to alter the weight applied to a particular order criteria), additional service provider qualification data (for example, requesting updated GPS data or safety certification renewal), or acceptance of an offer. In response, the user would interact with the system through user input interface 61, which updates the database and may affect the order status. For example, entry of updated data may result in re-filtering or re-ranking of qualified service providers, and acceptance of an offer would terminate the filtering and ranking process for that particular order

Moreover, failure to receive a user input in response to a system request may also affect the order status. For example, failure of a ranked service provider to respond to a request for location data may result in re-ranking, and failure of a customer user to respond to a request for order clarification may result in a suspension of the matching module for that order until suitable input is received. Further, failure to gain acceptance of any offer from ranked service provider users may result in repeating the matching module, communication with the customer user regarding amending the order parameters, or placing the order up for auction.

### EXAMPLE 1

In the field of transportation, registered customer ABC Oil Company wishes to arrange delivery of a shipment of crude oil. The authorized user from ABC Oil Company logs on to the system and selects ‘Tender Shipment’ option. A physical or electronic Tender Shipment form is filled out with the following details:

Bill To: ABC Oil Company

Commodity: Crude Oil

Pick up location: RBT Oil Terminals, Edson, AB

Earliest pick up time: 22/09/2009 8:00 am

Latest pick up time: 22/09/2009 8:30 am

Quantity to be picked up: 30 barrels

Drop off location: RBT Oil Terminals, Edmonton, AB

Earliest drop off time: 22/09/2009 10:30 am

Latest drop off time: 22/09/2009 11:00 am

Quantity to be dropped off: 30 barrels

The customer does not wish to do business with XYZ Trucking, so this is noted on the order.

The customer does not specify any preference for service quality rating, but requires a carrier safety rating of 1 or 2.

The Tender Shipment information is analyzed by the system for completeness and accuracy. For example, the drop off time must be later than the pick up time, etc. The system then accepts the order into the database, and issues order number 123 to the Customer as a reference number.

Additional shipping parameters for Crude Oil have been previously loaded in the system (or were entered with the order), identifying that Crude Oil must be shipped by tank truck. Each tank truck must have sour-sealed vents. Service providers that provide tank trucks with sour-sealed vents must have received safety orientation from ABC Oil Company and comply with the terms of ABC's transportation master service agreement. These service providers must also have received safety orientation from RBT Oil Terminals and wear personal protective equipment as set out in said orientation. Based on these criteria, the system applies appropriate filters to generate the following qualification list:

DEF Trucking; Safety Ranking 1; Quality Ranking 2

GHI Trucking; Safety Ranking 2; Quality Ranking 2

JKL Trucking; Safety Ranking 2; Quality Ranking 1

The filters resulted in exclusion of the following service providers for failure to receive ABC Oil Company orientation:

MNO Trucking; Safety Ranking 1; Quality Ranking 1

PQR Trucking; Safety Ranking 1; Quality Ranking 2

The filters excluded the following service providers for failure to receive RBT Oil Terminals orientation:

STU Trucking; Safety Ranking 1; Quality Ranking 2

VWX Trucking; Safety Ranking 2; Quality Ranking 2

Finally, XYZ Trucking was excluded from the qualification list as requested by ABC Oil Company.

The system sends a request to registered service providers DEF Trucking, GHI Trucking, and JKL Trucking requesting price quotes for the shipment, specifying the location, commodity, and time details of the ABC shipment. In the present case, the request is sent through the system website.

Independently, DEF Trucking, GHI Trucking, and JKL Trucking each log on to the system website or otherwise receive the system quote request. Each company confirms their binding offer for carriage of the ABC shipment. They may make repeated offers until the closing time of the offer.

During the offer period, each service provider can see the other service provider's offer, however the name attached to each offer is not revealed. Offers progress as follows:

DEF Trucking; $100

GHI Trucking; $99

JKL Trucking; $98

GHI Trucking; $95

JKL Trucking; $95

GHI Trucking; $94

DEF Trucking; $90

JKL Trucking; $89

The offers are used within the ranking system as specified by the Customer:

DEF Trucking; $90; Safety Ranking 1; Quality Ranking 2

JKL Trucking; $89; Safety Ranking 2; Quality Ranking 1

GHI Trucking; $94; Safety Ranking 2; Quality Ranking 2

Based on this ranked list, the system awards the shipment contract to DEF Trucking. DEF Trucking is notified of the contract, and a contract is formed between ABC Oil Company and DEF Trucking. GHI Trucking and JKL Trucking are notified that their offers were not accepted. Both ABC Oil Company and DEF Trucking are provided full information relating to each other's contact details and the status of the shipment. Shipment status is also tracked through the system.

EXAMPLE 2

In a similar example, ABC Oil Company has another order to enter into the system.

The Tender Shipment form is filled out with the following details:

Bill To: ABC Oil Company

Commodity: Crude Oil

Pick up location: RBT Oil Terminals, Edson, AB

Earliest pick up time: 22/09/2009 8:00 am

Latest pick up time: 22/09/2009 8:30 am

Quantity to be picked up: 30 barrels

Drop off location: RBT Oil Terminals, Edmonton, AB

Earliest drop off time: 22/09/2009 10:30 am

Latest drop off time: 22/09/2009 11:00 am

Quantity to be dropped off: 30 barrels

The customer does not wish to do business with XYZ Trucking, so this is noted on the order.

The customer does not specify any preference for service quality rating, but requests a carrier safety rating of 1.

The Tender Shipment information is analyzed by the system for completeness and accuracy. For example, the drop off time must be later than the pick up time, etc. The system then accepts the order into the database, and issues order number 234 to the Customer as a reference number.

Additional shipping parameters for Crude Oil have been previously loaded in the system (or were entered with the order), identifying that Crude Oil must be shipped by tank truck. Each tank truck must have sour-sealed vents. Service providers that provide tank trucks with sour-sealed vents must have received safety orientation from ABC Oil Company and comply with the terms of ABC's transportation master service agreement. These service providers must also have received safety orientation from RBT Oil Terminals and wear personal protective equipment as set out in said orientation.

In the present example, each carrier has a pre-negotiated lane rate for hauling oil from RBT Terminals in Edson to RBT Terminals in Edmonton. Based on these criteria, the system applies appropriate filters to generate the following qualification list:

DEF Trucking; Safety Ranking 1; Quality Ranking 2; lane rate $14.50

GHI Trucking; Safety Ranking 1; Quality Ranking 2; lane rate $17.50

JKL Trucking; Safety Ranking 1; Quality Ranking 1; lane rate 16.75

The following service providers were excluded on the basis that they did not receive ABC Oil Company orientation:

MNO Trucking; Safety Ranking 1; Quality Ranking 1; lane rate $14.50

PQR Trucking; Safety Ranking 1; Quality Ranking 2; lane rate $16.75

The following service providers were excluded on the basis that they did not receive RBT Oil Terminals orientation:

STU Trucking; Safety Ranking 1; Quality Ranking 2; lane rate $15.50

VWX Trucking; Safety Ranking 2; Quality Ranking 2; lane rate $15.75

XYZ Trucking is excluded from the list of service providers as requested by ABC Oil Company.

The system ranks the qualified service providers according to ABC criteria of Safety Ranking, and then by price:

DEF Trucking; Safety Ranking 1; Quality Ranking 2; lane rate $14.50

JKL Trucking; Safety Ranking 1; Quality Ranking 1; lane rate $16.75

GHI Trucking; Safety Ranking 1; Quality Ranking 2; lane rate $17.50

An email is sent to each trucking company in sequence offering them the shipment. A time limit of 30 minutes is set for each company to accept before the offer is retracted and offered to the next trucking company in the list:

DEF Trucking offered 10:13 am; no response; withdrawn 10:43 am

JKL Trucking offered 10:44 am; accepted 10:56 am

An email is sent to JKL Trucking notifying them of their award. No emails are sent to other trucking companies. A contract is formed between ABC Oil Company and JKL Trucking.

Both ABC Oil Company and JKL Trucking are provided full information relating to each other's contact details and the status of the shipment.

EXAMPLE 3

Registered customer ABC Pressure Vessels wishes to procure the services of a welder. The authorized user from ABC Pressure Vessels logs on to the system and selects ‘Tender Service Order’ option, or otherwise makes contact with the system for entry of the order. A physical or electronic Tender Shipment form is filled out with the following details:

Bill To: ABC Pressure Vessels

Service: Welding

Service provision location: ABC Pressure Vessels workshop, Red Deer, AB

Earliest service provision start time: 22/09/2009 8:00 am

Latest service provision start time: 22/09/2009 8:30 am

Service specific details: Pressure welding of 15 stainless steel tanks; drawings attached.

Service provision due date, earliest: 29/09/2009 5:00 pm

Service provision due date, latest: 29/09/2009 5:00 pm

Customer specifies quality ranking of 2 or higher firstly

Customer specifies safety ranking of 2 or higher secondly

System verifies Service Order information for completeness and accuracy. For example, the drop off time must be later than the pick up time, etc.

Order established and an order number is issued to Customer; 345.

Additional shipping parameters for Pressure Welding services have been previously loaded in the system (or were entered with the order), identifying that Pressure Welding requires tradesperson certification of Canadian Welding Board and/or Alberta Red Seal Certification for pressure welding. Service providers must have current Workers Compensation Board registration. ABC Pressure Vessels requires contracted service providers to be bondable and post a bond of 25% of the value of the Service Order prior to commencing provision of the service. Service providers must have received safety orientation from ABC Pressure Vessels and comply with the terms of ABC's welding contractor master service agreement. Based on these criteria, Maxen creates a list of possible service providers:

Sampson Welding; Safety Ranking 2; Quality Ranking 1

Flash Welding; Safety Ranking 1; Quality Ranking 2

True Welding; Safety Ranking 1; Quality Ranking 1

Lincoln Welding; Safety Ranking 2; Quality Ranking 2

The following service are excluded as they have not received ABC Pressure Vessel orientation:

Spot Welding; Safety Ranking 1; Quality Ranking 1

Hot Welding; Safety Ranking 1; Quality Ranking 2

The following service providers were excluded as their servece provider data did not indicate that they met the bondable requirement:

Flag Welding; Safety Ranking 1; Quality Ranking 2

Star Welding; Safety Ranking 2; Quality Ranking 2

Ratings are assigned to the qualified service providers according to ABC criteria of Quality Ranking and Safety Ranking:

True Welding; Safety Ranking 1; Quality Ranking 1

Flash Welding; Safety Ranking 1; Quality Ranking 2

Sampson Welding; Safety Ranking 2; Quality Ranking 1

Lincoln Welding; Safety Ranking 2; Quality Ranking 2

To obtain price information to use within the ranking system, an email is sent to each service provider requesting a quote for the service order within the next 72 hours.

Independently of each other, True Welding, Sampson Welding, Flash Welding, and JKL Trucking navigate to the Maxen website and log on to the system. They proceed to the ‘Service Provision Opportunity” page and fill out the form representing their binding offer for provision of the services as set out in the system-generated email. During the offer period, each service provider can see the other service provider's offer, or see the lowest-priced offer, however the name attached to each offer is not revealed.

The qualified service providers may make repeated competing offers until the closing time of the offer. Offers are received as follows:

True Welding; $1500

Sampson Welding; 1450

Flash Welding; $1475

Lincoln Welding; $1400

The qualified service providers are ranked as follows, based on ABC's weighted criteria:

True Welding; $1500

Flash Welding; $1475

Sampson Welding; $1450

Lincoln Welding; $1400

An email is sent from the system to True Welding notifying them they are the awardee of the contract. Emails are sent to Flash, Sampson and Lincoln informing them of their offer being declined. A contract is formed between ABC Pressure Vessels and True Welding. Both ABC Pressure Vessels and Flash Welding are provided full information relating to each other's contact details and the status of the shipment.

Following completion of the service, ABC Pressure Vessels can rate the service provided by True Welding for use in future matching.

The above-described embodiments of the present invention are intended to be examples only. Alterations, modifications and variations may be effected to the particular embodiments by those of skill in the art without departing from the scope of the invention, which is defined solely by the claims appended hereto.

1. A method for brokering industrial service contracts, the method comprising the steps of:
collecting qualification data obtained from a plurality of industrial service providers;
storing the qualification data within a database;
obtaining an industrial service request from a user, the service request comprising one or more service parameter inputs;
filtering the qualification data on the basis of the service parameter inputs to generate a qualification list of service providers qualified to fulfill the service request;
ranking each qualified service provider based on the correspondence of one or more service parameter inputs with the qualification data of that service provider;
making sequential, time-limited offers corresponding to the industrial service request on behalf of the user, to the qualified service providers in ranked order; and
confirming an accepted offer with the accepting service provider and the user.

2. The method as in claim 1, further comprising the step of periodically re-collecting qualification data.

3. The method as in claim 2, further comprising the step of periodically re-filtering the qualification data to update the qualification list.

4. The method as in claim 3, further comprising the step of periodically re-ranking the service providers included in the qualification list.

5. The method as in claim 1, wherein one or more steps are repeated until an offer is accepted by a qualified service provider.

6. The method as in claim 1, further comprising the step of prioritizing the service parameter inputs to assign a weight value to at least one of the service parameter inputs.

7. The method as in claim 6, wherein the weight value is used during the filtering step to eliminate one or more service providers from the qualification list.

8. The method as in claim 6, wherein the weight value is used during the ranking step to compare qualified service providers based on the correspondence of each service parameter input with the available qualification data of each service provider.

9. The method of claim 1, wherein the qualification data comprises at least one of:
GPS location of the service provider, capacity of the service provider to accept a new contract, estimated price of completing the service, safety certification of the service provider, equipment availability, and estimated time to reach the service location.

10. The method of claim 1, further comprising the step of requesting additional qualification data from qualified service providers, based on the service parameter inputs.

11. The method as in claim 1, wherein the step of ranking comprises calculating a score for each service provider based on the degree of correspondence between each service parameter input and the qualification data available for that service provider.

12. The method as in claim 1, further comprising the step of modifying the offer to gain offer acceptance by a qualified service provider.

13. The method as in claim 1, further comprising the step of offering the service request to two or more service providers for competitive bids when the time-limited offers do not result in acceptance of an offer.

14. The method as in claim 13, wherein the service request is offered to two or more service providers in an auction format.

15. The method as in claim 1, wherein the customer service parameter inputs comprise at least one of: a completion deadline; a fixed price; a maximum price; a preferred service provider identity; a listing of unsuitable service providers; a safety certification requirement: a prerequisite requirement; carriage of a specific insurance policy; specific equipment request; and a minimum reliability rating.

16. The method as in claim 1, wherein the industrial service request is selected from the group consisting of: a request for equipment maintenance, a request for training; a request for inspection; a request for shipping of goods; a request for an expert opinion; a request for service access to a skilled tradesperson; a request for geological services; a request for testing; a request for surveillance; a request for security services; a request for cleaning services; and a request for consultant services.

17. The method as in claim 1, wherein each customer service parameter input comprises a user-entered priority value.

18. The method as in claim 17, wherein the priority value is entered in respect of service parameter inputs that the user considers to be required of the service provider.

19. The method as in claim 18, wherein the qualification step excludes service providers whose qualification data does not correspond to service parameter inputs associated with the priority value.

20. The method of claim 17, wherein the priority value is a score entered by the user in respect of each service parameter input to prioritize the service parameters.

21. The method as in claim 17, wherein the step of ranking each qualified service provider comprises the step of assigning a score to each service provider in respect of each service parameter input based on the correspondence of each service provider's qualification data to the prioritized service parameter inputs, and then ranking the qualified service provider.

22. The method as in claim 17, wherein the step of ranking each qualified service provider comprises: assigning a score to each service provider in respect of each service parameter input, based on the correspondence of each service parameter with the service provider's qualification data; and, in respect of each service provider, processing each score in respect of the user-entered priority value for each service parameter to arrive at an overall ranked list of service providers.

23. The method of claim 1, wherein service providers are blinded to the identity of the user until an accepted offer is confirmed.

24. The method of claim 23, wherein the user is blinded to the identity of the service providers until an offer is confirmed.

25. The method of claim 1, wherein the offers are made confidentially to service providers.

26. A system for brokering industrial service contracts, the system comprising:
a registration module for collecting registration data from customer users and service provider users. the registration module comprising: an input component for collecting order request data from customer users and qualification data from service provider users; and a database component for storing said order data and qualification data;
a matching module for querying the database in respect of the order request data to generate a match and resulting contract between a customer user and a service provider user, the matching module comprising: a processor for ranking service provider users with respect to the order request data, and for making sequential time-limited contract offers corresponding to the order request data to ranked service provider users, on behalf of the customer user.

27. The system as in claim 26, wherein the input component comprises a website, mobile device, telephone line, system kiosk, or personal interaction.

28. The system as in claim 26, wherein the input component, database component, and matching module are connected by a data communication network.

29. The system as in claim 26, further comprising a request component for requesting additional data from a user.

30. The system as in claim 29, wherein the additional data is a confirmation input indicating acceptance of a contract by a user.

31. The system as in claim 29, wherein the additional data is additional qualification data.

32. The system as in claim 29, wherein the further data is additional order request data.

33. The system as in claim 28, wherein the network is a dedicated network, LAN, WAN, or the Internet.

34. A system for matching registered customer users in need of service, with registered service provider users qualified to provide the service, the system comprising:
a user interface for collecting service order data from customer users, and for collecting qualification data from service provider users;
a database for storing the service order data and the qualification data;
a communication interface for requesting input from users;
a processor for querying the database in respect of each service order and executing a matching module to generate a ranked list of qualified service provider users corresponding to the service order data; and
an offer module for generating contract offers corresponding to the service order, communicating said offers sequentially to the qualified service provider users in ranked order via the communication interface, and requesting acceptance of same within a specified period of time.

35. The system as in claim 34, wherein the input requested by the communication interface is additional order data.

36. The system as in claim 34, wherein the input requested by the communication interface is additional qualification data.

37. The system as in claim 36, wherein the input requested by the communication interface is GPS data.

38. The system as in claim 34, wherein the user interface comprises a website, telephone, or mobile device network.

39. The system as in claim 34, wherein the communication interface comprises a website, telephone, or mobile device network.
